(19) United States
(12) Patent Application Publication
(10) Pub. No.: US 2020/0162762 A1
(43) Pub. Date: May 21, 2020

(54) METHOD AND DEVICE TO PROVIDE RECEIVER PERSPECTIVE FOR MOBILE STREAMING VIDEO

(71) Applicant: MOTOROLA SOLUTIONS, INC, CHICAGO, IL (US)

(72) Inventors: WYATT BORSOS, CHICAGO, IL (US); TRENT J. MILLER, WEST CHICAGO, IL (US); STEVEN D. TINE, CHESHIRE, CT (US)

(21) Appl. No.: 16/196,261

(22) Filed: Nov. 20, 2018

(51) Int. Cl. H04N 19/895; H04N 19/44

(52) U.S. Cl. CPC H04N 19/895; H04N 19/44

(57) ABSTRACT

A method and device to provide receiver perspective for mobile streaming video is provided. In one aspect, an example method includes receiving, by a video receiver device, an encoded video stream transmitted over a wireless communications link. The method includes decoding the encoded video stream. The method further includes generating a decoding log. The decoding log stores metadata associated with the decoding. The method further includes signing the decoding log. The method further includes sending the signed decoding log to a Digital Evidence Management System (DEMS) for storage.

### BACKGROUND

Cameras that can record full motion video have become ubiquitous. Large numbers of people currently carry at least one device with them at almost all times that is capable of recording video. For example, large numbers of adults (and in fact children as well) may carry a mobile smartphone. Smartphones are typically equipped with the ability to capture still photographs as well as full motion video. Furthermore, most smartphones are equipped with wireless networking functionality (e.g. Long Term Evolution (LTE), 3G, 4G, 5G, WiFi) which allow the smartphone to stream captured video over a network to remote locations in order to be viewed in near real time by interested observers.

Another category of device that is capable of recording video is a Body Worn Camera (BWC) that may be worn by public safety personnel, such as police officers. A police officer may use a BWC to record interactions with the public (e.g. civilians, criminal suspects, etc.). The video captured by a police officer's BWC may eventually become evidence that may be used in a criminal proceeding. Just as with a smartphone, in many cases the BWC may be directly equipped with networking functionality in order to allow the captured video to be streamed to remote locations. Even in cases where the BWC is not directly equipped with networking functionality, the BWC may be coupled to another device, such as the officers portable radio or smartphone, that would allow video from the BWC to be streamed to a remote location.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example of an environment utilizing the techniques described herein to provide receiver perspective for mobile streaming video.

FIG. 2 is an example of a flowchart for creating decoding logs and playout logs utilizing the techniques described herein to provide receiver perspective for mobile streaming video.

FIG. 3 is an example of a flowchart of a method for recreating a receiver perspective for mobile streaming video according to the techniques described herein.

FIG. 4(A,B) are examples of devices that may be utilized to provide receiver perspective for mobile streaming video according to the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The capabilities of cameras, both smartphone and BWC, are constantly improving. For example, many smartphone cameras and BWC are capable of recording in High Definition (HD) resolution of 1080 p at 60 frames per second (fps). It is to be entirely expected that future generations of video capture devices (i.e. smartphones, BWC, etc.) will continue to improve the resolution at which they record. These video capture devices may internally store captured video at the resolution at which it was captured. Typically, video coders/decoders (codec) produce output files that are proportional to the resolution of the captured video. As the resolution increases, the file size increases.

Unfortunately, the rate of improvement of wireless networking technologies has not increased at the same pace as improvements in video codecs. As video resolution increases, there is typically insufficient wireless network bandwidth to stream the high resolution video to remote locations directly. Because the wireless bandwidth may not be available, a video capture device may convert the original high resolution video stream to a lower resolution stream in order to use less bandwidth. For example, a 1080p at 60 fps stream may be reduced to a 720p at 60 fps stream prior to streaming to a central server. Additionally, the capture device may reduce the frame rate of the video in order to use less bandwidth.

The same wireless bandwidth issue can occur on a video stream sent from the central server to a remote observer. For example, the remote observer may have a low bandwidth wireless connection that would not support receiving a 720p at 60 fps video stream. As a result, the central server may, for example, convert the stream to a 480p at 30 fps stream. It should be clear that converting a stream from a higher resolution to a lower resolution results in degradation of the video stream. For example, motion may appear blurry, details in the video may be less sharp, or any other such artifacts may result from the lower resolution. In addition, the wireless data link to a remote observer may experience transmission issues (e.g. dropped packets on the wireless link, dropped video frames during decoding, bit errors, etc.) which can also result in degradation of the quality of the video image. Regardless of the source of the degradation (e.g. resolution conversion, wireless link issues, etc.) it should be understood that a remote observer may not be viewing the video image at the same quality at which the video image was captured.

In a public safety scenario, decisions may be made based on the streamed video, and those decisions may have significant real world consequences. For example, a field police officer may capture video of an incident that may require the use of force (e.g. officer believes he sees a suspect waiving a gun). The field officer may stream the video to a supervisor to get approval for the use of force (e.g. authorization to use less than lethal or possibly lethal force). The supervisor makes this decision based on the information at hand, which in this case may be a video stream that is at a lower quality than that at which the video was captured. In general, the supervisor's decision will be judged based on a reasonableness standard, meaning the question is would a hypothetical objectively reasonable supervisor, viewing the video that was received, make the same decision as the real supervisor made.

A problem arises in the way that digital evidence, such as the video captured by the field officer's video capture device, is managed. Typically, a field officer does not upload captured video to a digital evidence management system (DEMS) over a lower bandwidth wireless connection. Rather, the officer may periodically (e.g. at the end of his shift) connect his device to a DEMS via a high speed connection (e.g. a wired connection, or a short range, high bandwidth wireless connection) directly to the DEMS in order to store the original, high resolution video that was captured and stored internally on the officer's device. This high resolution video may then be used for evidentiary purposes.

The problem that arises is that decisions may have been made based on the lower quality video stream. The reasonableness of those decision must be judged in view of what was actually received, not what was originally recorded. In the example above, determining the presence/absence of a weapon when viewing a 1080p at 60 fps video stream may be quite simple. However, that same decision becomes considerably more complex when viewed in a lower quality video stream due to the degradation of the video image that accompanies the conversion to the lower quality stream. In other words, a decision that is reasonable in view of a high quality video stream may be unreasonable in view of a low quality video stream (and vice versa).

The techniques described herein overcome these and other problems. A video stream received from a video capture device (e.g. BWC) may be stored at a DEMS. The video stream that is stored may be at a lower resolution than what was originally captured and stored on the video capture device. The received video may be transcoded to one or more lower resolutions and stored in the DEMS as well. When streaming to a remote observer, the capabilities of the receiver (e.g. available bandwidth, device capabilities, etc.) may be determined in order to decide which stored video stream to send to the remote observer.

The remote observer's device may store metadata related to the received video stream (e.g. dropped packets, dropped frames, etc), decoder being used (e.g. device hardware type, software/firmware version of the decoder, decoder errors encountered, etc) and the decoding of that stream (e.g. hashes over decoded frames, etc.) in a signed decoding log. Additionally, the remote observer's device may store information about the rendering of the decoded video stream (e.g. video app in background, display off, dropped frames, digest of displayed video, final display resolution, device operating mode such as power saving, etc.) in a signed playout log. Both the signed decoding log and the playout log may then be sent to the DEMS for storage.

The video stream that was actually viewed by the recipient may be recreated by retrieving the version of the video stream that was sent to the remote observer from the DEMS. The decoding log may then be applied to the video stream to recreate any alterations to the stream that happened at the recipient's device during the decoding process. The playout log may be applied to the decoded video stream to recreate any alterations to the stream that happened at the recipient's device during the rendering process. The decoding and playout logs include digests and hashes that may be used to prove that the recreated video is the same as the video that was actually viewed by the recipient. Thus, when making a judgement about the reasonableness of the recipient's decision, the judgment can be made while viewing what the recipient actually saw, not the highest resolution version of what was captured.

An example method includes receiving, by a video receiver device, an encoded video stream transmitted over a wireless communications link, decoding the encoded video stream, generating a decoding log, wherein the decoding log stores metadata associated with the decoding, signing the decoding log, and sending the signed decoding log to a Digital Evidence Management System (DEMS) for storage.

In one aspect, the method further includes generating a playout log, wherein the playout log stores output characteristics of a rendering of the decoded video stream on a viewing device, signing the playout log, and sending the signed playout log to the DEMS. In one aspect, the metadata associated with the decoding include one or more of: packets lost over the wireless communications link, packets discarded during the decoding, frames discarded during the decoding, a hash value of at least a portion of at least one video frame, a hash value of at least one group of pictures (GOP), a hash value of at least one element of a single video frame, and device characteristics of the video receiver device.

In one aspect the decoding log further includes: an operating system of the video receiver device, a chipset used by the video receiver device, and a decoder used by the video receiver device. In one aspect, the method further includes generating a digest of the rendering of the decoded video stream, and adding the digest to the playout log. In one aspect, the playout log comprises any modifications made to the decoded video stream during rendering of the decoded video stream. In one aspect, the playout log further comprises a status of a device used to render the decoded video stream. In one aspect, generating the digest of the rendering of the decoded video stream further comprises periodically calculating a hash for at least a portion of at least one frame of the rendered decoded video stream.

An example non-transitory processor readable medium containing a set of processor executable instructions thereon is provided. When executed by the processor the instructions cause the processor to: retrieve an encoded video stream from a Digital Evidence Management System (DEMS), retrieve a decoding log from the DEMS, decode the encoded video stream by applying the decoding log to the encoded video stream, and render the decoded video stream.

In one aspect, the medium further comprises instructions to: retrieve a playout log from the DEMS evidence management system, apply the playout log to the decoded video stream, and generate a digest of the rendered decoded video stream. In once aspect, the medium further comprises instructions to: retrieve a source digest from the playout log, and compare the digest and the source digest to determine if the rendered decoded video stream is the same as a video stream used to create the source digest. In once aspect, the medium further comprises instructions to: transcode the retrieved encoded video stream.

An example device may include a processor and a memory coupled to the processor, the memory containing a set of processor executable instructions that when executed by the processor cause the processor to: receive, by the device, an encoded video stream transmitted over a wireless communications link, decode the encoded video stream, generate a decoding log, wherein the decoding log stores metadata associated with the decoding, sign the decoding log, and send the signed decoding log to a Digital Evidence Management System (DEMS) for storage.

In one aspect, the device may further comprise instructions to: generate a playout log, wherein the playout log stores output characteristics of a rendering of the decoded video stream on a viewing device, sign the playout log, and send the signed playout log to the DEMS for storage. In one aspect, the metadata associated with the decoding include one or more of: packets lost over the wireless communications link, packets discarded during the decoding, frames discarded during the decoding, a hash value of at least a portion of at least one video frame, a hash value of at least one group of pictures (GOP), a hash value of at least one element of a single video frame, and device characteristics of the device.

In one aspect, the decoding log further includes: an operating system of the device, a chipset used by the device, and a decoder used by the device. In one aspect the device further comprises instructions to: generate a digest of the rendering of the decoded video stream, and add the digest to the playout log. In one aspect, the playout log comprises any modifications made to the decoded video stream during rendering of the decoded video stream. In one aspect, the playout log further comprises a status of the device used to render the decoded video stream. In one aspect generating the digest of the rendering of the decoded video stream further comprises instructions to periodically calculate a hash for at least a portion of at least one frame of the rendered decoded video stream.

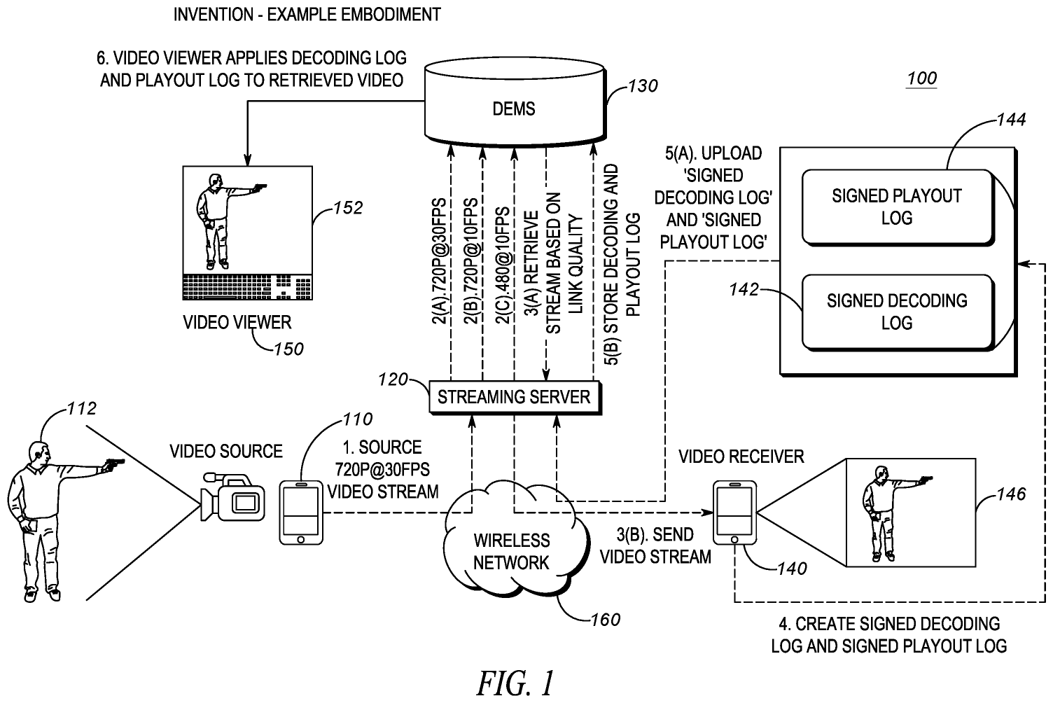

FIG. 1 is a block diagram of an example of an environment utilizing the techniques described herein to provide receiver perspective for mobile streaming video. System 100 may include a video source 110, a streaming server 120, a digital evidence management system (DEMS) 130, a video receiver 140, and a video viewer 150. The video source, streaming server, and video receiver may be coupled via a wireless network 160.

The video source 110 may be any type of video capture device. For example, the video source may be a Body Worn Camera (BWC) worn by a public safety officer, a drone, a closed-circuit television camera (CCTV), mobile device camera, and the like. The video source may also be a smartphone carried by the public safety officer. Although FIG. 1 is being described in the context of public safety, it should be understood that the techniques described herein are not limited to any particular use case and would be applicable to any video source in any situation. For example, the video source may be a fixed or pan-tilt-zoom capable surveillance camera, a vehicle dashboard camera, a standalone video camera, or any other device that is capable of streaming video (either directly or through a coupled device) through a wireless network.

Video source 110 may be coupled to a wireless network 160. The techniques described herein are not limited to any particular type of wireless networks. For example, the wireless network may be a mobile wireless network, such as an LTE, 3G, 4G, 5G publically available commercial cellular telephone network. The network may be a private, public safety wireless network such as a Land Mobile Radio (LMR) network (e.g. conventional or trunked analog wireless network, P25 network, Tetra Network, DMR network, PCR network, or other private broadband system). The wireless network may be a data centric network such as a WiFi or WiMax network. Although several types of wireless networks have been mentioned, it should be understood that any wireless network capable of being used to stream video between the video source 110, streaming server 120, and video receiver 140 are suitable for use with the techniques described herein.

Streaming server 120 may be any device capable of receiving a video stream via the wireless network 160. For example, the streaming server may be a computer, including a processor and memory that is capable of executing instructions to implement the functionality described herein. Streaming server may include necessary circuitry to enable the streaming server to connect to the wireless network. The streaming server may additionally include functionality to receive a video stream from the wireless network and transcode that video stream to one or more lower resolutions. The streaming server may include functionality to store the original video stream and any transcoded streams into a DEMS 130, which is described below.

The streaming server 120 may also receive log files, such as decoding and playout log files over the wireless network 160. The streaming server may store those log files into the DEMS 130. In some implementations, log files are stored directly into the DEMS, without going through the streaming server. The streaming server may also be capable of retrieving the video streams (the original as well as any transcoded streams) from the DEMS. The streaming server may also be capable of sending the retrieved video stream to a video receiver 140. In some implementations, the streaming server may directly stream the original or transcoded stream directly to the video receiver.

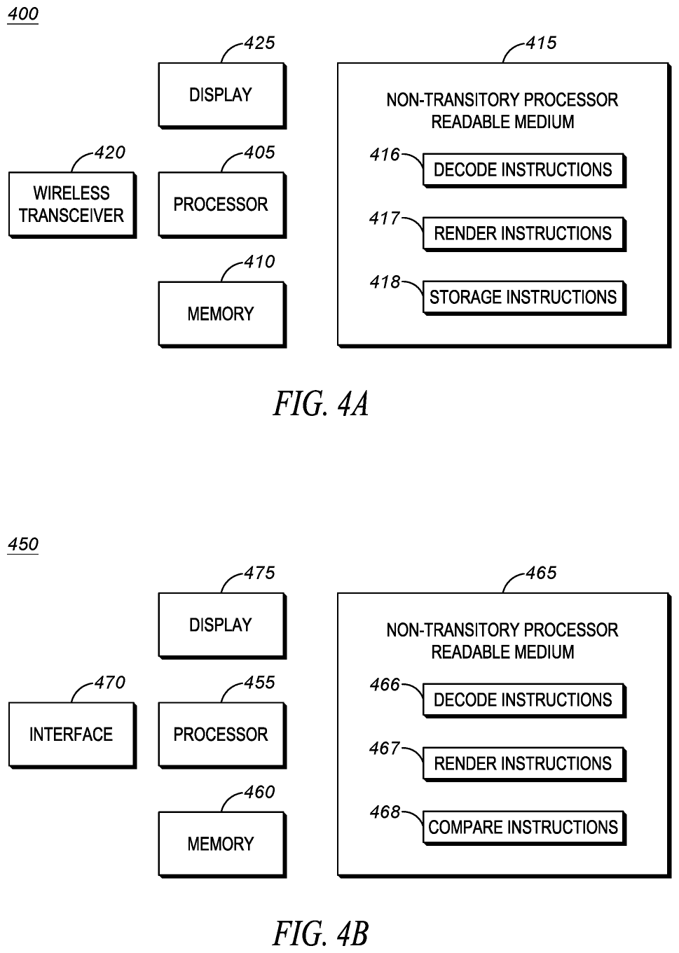

The video receiver 140 may be any device capable of receiving a video stream over wireless network 160 and causing that stream to be displayed. For example, the video receiver may include a smartphone. The video receiver may include a BWC that contains a display screen. The video receiver may include a device that can connect to the wireless network to receive a video stream but does not include a screen itself, but rather is coupled to another device that includes a display on which the video stream can be rendered. The video receiver is also capable of processing the received video stream to extract data related to the video stream decoding and rendering process. This data can be included in decoding and playout logs, which are described in further detail below. In some implementations, the video receiver is also capable of transmitting files, such as the decoding and playout logs via the wireless network. The video receiver is described in further detail with respect to FIG. 4.

The digital evidence management system 130 may be a database used to store video streams, decoding logs, playout logs, and any other types of digital data that may be generated. In a public safety context, agencies typically utilize a DEMS in order to provide a secure location to manage electronic data that may need to be used in court for evidentiary purposes. A DEMS will typically provide the ability to establish the chain of custody for digital evidence uploaded into the system. For example, a DEMS may utilize digital signing of files to ensure the authenticity of those files. It should be understood that although FIG. 1 is being described in a public safety context, the techniques described herein are not so limited. The DEMS could be replaced with any type of database capable of storing digital information.

System 100 may also include a video viewer 150. The video viewer may be any person/entity that wishes to view a video stream that appears exactly the same as the video stream was viewed by the video receiver 140. The video viewer may be viewing the video at a later time than the video was initially streamed to the video receiver. For example, the video viewer may be a court that is recreating the video seen by the video receiver in order to determine if the actions of the video receiver were reasonable.

In operation, a video source 110 may be operated by a user in order to capture video of an event. For example, in a public safety context, the video source may be a BWC worn by a police officer and the event being captured is an interaction with the public or a suspect. As shown in FIG. 1, the event 112 may be a subject waiving what is clearly visible as a gun on a public street. The recorded video may be stored on the video source device at the resolution in which it was captured. For example, the video may be stored at a 1080p @ 60 fps resolution, which is generally considered a high definition (HD) resolution.

In step 1, the video source 110 may utilize wireless network 160 in order to stream the captured video to the streaming server 120. Depending on the quality of the wireless network connection between the video source device and the wireless network, there may not be sufficient bandwidth available to send the original 1080p@60 fps video stream. As a result, the video source may send the video stream at a lower resolution based on the available bandwidth. For example, as shown in step 1, the video stream may be sent as a 720p@30 fps stream.

The streaming server 120 may receive the video stream from the video source 110. As shown in step 2(a), the streaming server may store the stream, as received, in the DEMS 130. It should be noted that the stream stored in step 2(a) is the video stream as received from the wireless network 160. If there are any issues with the transmission (e.g. dropped packets, dropped frames, etc.) as received in step 1, those issues will be reflected in the video stream stored in step 2(a). In addition, the streaming server may transcode the received stream into lower resolution streams. For example, as shown in step 2(b), the received video stream may be transcoded from 720p@30 fps to 720p@10 fps. In step 2(c) the received video stream may be transcoded from 720p@30 fps to 480p@10 fps. Use of the lower resolution streams is described in further detail below. It should also be noted that at a later time, the original, high resolution 1080p@60 fps video may be loaded directly into the DEMS system (not shown). For example, at the end of an officer's shift, he may return to the station house and connect to the DEMS system directly (e.g. through a wired connection or a high speed local wireless connection) and upload the high resolution original stream into the DEMS system to more accurately reflect what the officer himself saw when viewing the scene live.

In step 3(a), a video stream that was stored in the DEMS 130 may be retrieved. For example, one of the streams that was stored in step 2 may be retrieved. The particular resolution of the video stream that is retrieved may be based on the quality of the wireless link connection between the video receiver 140 and the wireless network 160. For example, a higher quality connection may support a higher resolution stream while a lower quality connection may only support a lower resolution stream. In some implementations, the video stream is not retrieved from the DEMS, but rather is obtained directly from the transcoding process mentioned in step 2. In step 3(b) the retrieved video stream, at a resolution supported by the wireless connection to the video receiver, may be sent to the video receiver.

In step 4, the video receiver 140 may receive the video stream from the wireless network 160. The video receiver may decode the video stream. The process of decoding the video stream may include the steps necessary to prepare the video stream for rendering on a video display device. For example, the decoding process may include processing the video stream to handle lost packets, lost frames, corrupted frames, etc. The decoding process may also include uncompressing the video stream using the proper codec. As will be described in further detail below, the metadata associated with decoding the video stream may be stored in a decoding log. The decoding log may be signed to create a signed decoding log 142. The signed decoding log may be used at a later time to prove the authenticity of the decoding log.

The decoded video stream may then be rendered on a display device. In some implementations, the display device is integrated with the device receiving the video stream (e.g. a screen on a smartphone). In other implementations, the rendering may occur on a display device that is external to the device receiving the video stream. For example, the device decoding the video stream may cast the rendering to another device that includes a display device (e.g. the rendering may be cast to a television). As will be described below, a digest of the rendering process may be created. The digest, as well as other characteristics of the rendering process (e.g. dropped frames, display in background, etc.) may be stored in a playout log. The playout log may be signed to create a signed playout log 144. The rendered video may be displayed on the display device 146.

In step 5(a), the signed decoding log 142 and the signed playout log 144 may be sent from the video receiver 140 to the streaming server 120 via the wireless network 160. The streaming server may then, in step 5(b), store the signed decoding and rendering logs to the DEMS 130. In an alternate implementation, the signed decoding log 142 and signed playout log 144 may be directly uploaded to the DEMS. For example, just as the video source may directly upload the original video stream to the DEMS (e.g. at end of shift over a high speed link), the video receiver may do the same. As will be described below, the log files may be used to recreate the rendering 146 of the video stream, as it was seen by the video receiver.

At some later point in time, a video viewer 150 may desire to view the rendered video stream 146 as it was seen at the video receiver 140. For example, in a court setting, the court may wish to view the rendered video stream 146 to judge the reasonableness of the actions of a person viewing the stream. It should be understood that court usage is simply one example of a use case for the techniques described herein. The techniques may be utilized to recreate the rendering of the video stream 146 for any purpose.

In step 6, the video viewer may retrieve the video stream that was sent to the video receiver 140 at the resolution that was actually sent to the video receiver in step 3 from the DEMS 130. The video viewer may additionally retrieve the signed decoding and playout logs that were stored in step 5 from the DEMS. The signatures can be verified to ensure that the logs files have not been altered. The video viewer may then decode and render 152 the video stream exactly as it was decoded and rendered by the video receiver by applying the decoding and playout logs to the video stream. The rendered video stream 152 will be the same as the rendered video stream 146. As will be described in further detail below, the contents of the log files may additionally be used to verify that the rendering done by the video viewer 150 is the same as that which was rendered by the video receiver 140, thus ensuring that the video viewer is viewing exactly what was viewed by the video receiver.

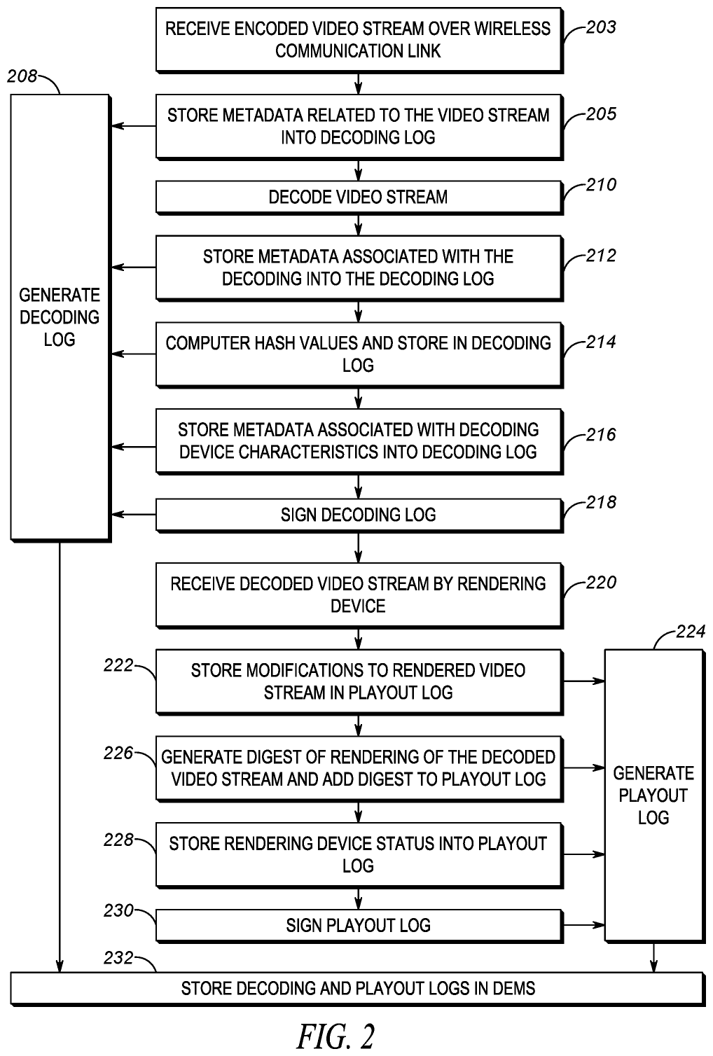

FIG. 2 is an example of a flowchart for creating decoding logs and playout logs utilizing the techniques described herein to provide receiver perspective for mobile streaming video. In block 203, the encoded video stream may be received by the video receiver 140 from the streaming server 120 over a wireless communication link, as was described in FIG. 1, step 3. In block 205, metadata related to the video stream may be stored into the generated decoding log 208. Some examples of metadata that may be stored are any packets that were lost over the wireless connection to the wireless network 160. Metadata may also include any packets that were discarded. For example, some packets may be received, but with data corrupted to the point where error correction schemes can no longer correct the errors. Those packets, although received, may be discarded. Other types of metadata have been mentioned above. The metadata related to the stream may be used to recreate the video stream as received by the video receiver.

In block 210, the received video stream may be decoded. For example, the decoding process may include applying the same codec (manufacturer and version) that was used to code the originally captured video frames to the received stream in order to recover the original frames of the recorded video. In block 212, metadata describing the results of the decoding process may be stored in the decoding log 208. Some examples of the decoding metadata that may be captured may include packets discarded during the decoding (e.g. due to errors) and frames discarded as part of the decoding process. Such metadata may be used in order to recreate the decoding process. The result of the decoding process may be a series of video frames (or portions of video frames).

In block 214 hash values may be computed over the decoded frames in order to provide a later verifiable indication of the result of the decoding process. The techniques described herein are not dependent on any particular form of hash calculation. For example, in one implementation, a hash value may be computed for each decoded frame and that value is stored in the decoding log. In another implementation, the hash value may only be computed for a portion of each frame. In yet another implementation, a hash value may be computed over several frames (or portions of several frames) and stored in the decoding log. In yet another implementation, the hash value may be computed on at least one group of pictures (GOP) made up of several decoded frames. In yet another implementation, the hash value may be computed of at least one element of a single video frame. What should be understood is that any hash value computed over one or more complete or portions of the decoded video frames that is able to provide a verifiable representation of the decoded video stream are suitable for use with the techniques described herein. The computed hash value may be stored in the decoding log 208. Hash values generated by the video receiver may be referred to as source hash values.

In block 216 characteristics of the device used to decode the video stream may be stored as metadata in the decoding log file. Some example characteristics of the decoding device may include the operating system used by the device. For example, the type and version of the operating system. Another example characteristic may include the chipset used by the decoding device. Again, this may include the type and version. This may further include the chipset's associated firmware version. As yet another example, the type and version of the decoder (either hardware or software). These characteristics may be used when recreating the decoded video stream at a later time as they can be used to ensure that the types and versions of the hardware and software used in the later decoding produces the same results as those used during the original decoding.

In block 218, the decoding log may be signed (e.g. digitally signed) using any suitable signature technique in order to later prove that the decoding log is authentic and has not been altered. The techniques described herein are not dependent on any particular scheme for singing the decoding log, so long as the scheme is able to prove that the decoding log was created by the decoding device and has not been altered since the time of creation.

After the video stream is decoded, the decoded frames need to be rendered on a display device. In some cases, the display device may be integrated with the decoding device (e.g. a smartphone with an integrated display screen). In other cases, the display device may be remote from the decoding device (e.g. a smartphone used to decode the video stream while casting the video to a large screen television for rendering).

When the rendering device is located remotely from the decoding device, there may be issues related to the communications link connecting the decoding device to the rendering device. As a result of such issues, video frames may be dropped or otherwise altered. Modifications to the video stream may also be necessary based on the particular device on which the video stream is rendered. The status of the rendering device itself may determine what the video receiver actually viewed.

In block 220, the decoded video stream may be received by the rendering device. As mentioned above, the rendering device may be integrated with the decoding device or may be separate from the decoding device. In block 222, any modifications to the rendered video stream may be stored in a generated playout log 224. As mentioned above, modifications to the rendered video stream may include video frames dropped by the rendering device (e.g. due to corruption or for any other reason).

In block 226, a digest of the rendering of the decoded video stream may be generated. Just as above with respect to creating hashes over the decoded video frames, the same type of criteria may be used to create a digest of the rendered video stream. For example, a hash may be periodically calculated for at least a portion of at least one frame of the rendered decoded video stream. Such a hash can represent what was actually rendered on the video display device. As above, such a hash could be calculated over one or more rendered video frames. The hash may further be over a portion or the complete frame of each rendered video frame. The techniques described herein are not dependent on any particular form of a digest, so long as the digest can be used to verify what was actually seen by the video receiver. The generated digest may be stored in the playout log 224. The digest generated at the video receiver may also be referred to as the source digest.

In block 228, a status of the rendering device may be stored in the playout log 224. The status of the rendering device may include anything that may impact how the video stream was rendered on the display device. For example, if the display device screen was locked (indicating nothing was displayed) or the actual resolution/size of the rendered video or if the rendered video was in the background, and was thus either partially or completely obscured by one or more applications in the foreground of the display device. Any information related to the status of display device that affects how the video stream was rendered may be stored in the playout log (including the device's operating mode, such as low-power mode).

In block 230, the playout log may be signed (e.g. digitally signed) using any suitable signature technique in order to later prove that the playout log is authentic and has not been altered. The techniques described herein are not dependent on any particular scheme for singing the playout log, so long as the scheme is able to prove that the playout log was created by the rendering device and has not been altered since the time of creation.

In block 232, both the signed playout log and the signed decoding log may be sent to the DEMS for storage. It should be understood that although FIG. 2 is described in a serial format, this was simply for ease of description. In actual implementation, the process described in FIG. 2 occurs continuously (e.g. the decoding and rendering process occurs continuously as the video stream is received). In some implementations, the decoding and playout logs are not sent to the DEMS until the video stream have been completely viewed. In other implementations, the decoding and playout logs may periodically be sent to the DEMS (e.g. after a fixed interval of time, such as every 1 second, 5 seconds, or 10 seconds).

The process of recreating the displayed video stream by the video viewer follows a similar flow as the process depicted in FIG. 2. However, instead of the video stream being received from a wireless network, the video stream (at the resolution that was originally sent) is retrieved from the DEMS. Furthermore, instead of recording the factors that altered the video stream in the decoding and playout logs, the decoding and playout logs are applied to the retrieved video stream in order to recreate any modifications to the video stream that were done by the video receiver. The video viewer computes its own hashes and digest of the decoded and rendered video stream, using the same algorithm that was used by the video receiver. If the hashes and digest generated by the video viewer, which can also be referred to as the viewer hash and the viewer digest, are the same as those that were stored in the decoding and playout logs by the video receiver (e.g. the source hash and source digest), this means the video viewer is viewing the exact same video that was viewed by the video receiver.

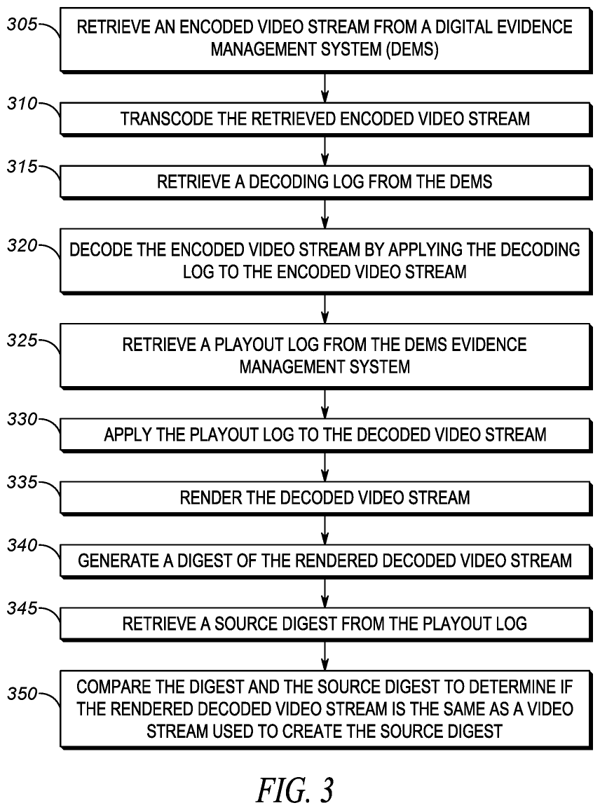

FIG. 3 is an example of a flowchart of a method for providing receiver perspective for mobile streaming video according to the techniques described herein. In block 305 an encoded video stream may be retrieved from a Digital Evidence Management System (DEMS). In one implementation, the retrieved video stream that is retrieved is the same stream that was sent to the video receiver (e.g. step 3 of FIG. 1). In an alternate implementation, the original high resolution stream may be retrieved.

In block 310, the retrieved encoded video stream may be transcoded, if necessary. For example, in the case where the original high resolution video stream is stored in the DEMS, the original video stream may be transcoded to the resolution that was actually sent to the video receiver. It should be clear that block 310 is not necessary in an implementation in which the transcoded streams are stored in the DEMS prior to sending to the video receiver.

In block 315, a decoding log may be retrieved from the DEMS system. The decoding log may be the signed decoding log that was described in FIG. 2. The signature of the decoding log may be verified to ensure that the decoding log has not been tampered with since it was stored in the DEMS. In block 320, the encoded video stream may be decoded by applying the decoding log to the encoded video stream. In other words, the metadata stored in the decoding log (e.g. dropped packets, dropped frames, etc.) is applied to the decoded video stream in order to recreate the same decoded video stream that was present after decoding at the video receiver.

In block 325 a playout log may be retrieved from the DEMS. The playout log may be the signed playout log that was described in FIG. 2. The signature of the playout log may be verified to ensure that the playout log has not been tampered with since it was stored in the DEMS. In block 330, the playout log may be applied to the decoded video stream. In other words, the output characteristics stored in the playout log (e.g. dropped packets, dropped frames, display off, application obscured in background, etc.) is applied to the decoded video stream in order to recreate the same video stream that was present after rendering at the video receiver.

In block 335, the decoded video stream with the playout log applied may be rendered. The rendering may include aspects such as scaling the screen size/resolution of the video viewer to match the screen size/resolution of the video receiver. For purposes of this example, it may be assumed that the rendering of the video stream is the same as that which was generated in step 330. In other words, no further modifications to the rendering are inserted as part of the rendering in block 335. In block 340, a digest of the rendered decoded video stream is generated (e.g. the viewer digest). In other words, the same process used to create the digest as described with respect to FIG. 2 (e.g. the source digest) is used to create a digest at the video viewer.

In block 345 a source digest may be retrieved from the playout log. The source digest may have been generated as described in FIG. 2, and represents the actual video that was viewed by the video receiver. In block 350 the viewer digest and the source digest may be compared to determine if the rendered decoded video stream is the same as a video stream used to create the source digest. In other words, if the source digest and the generated viewer digest are the same, this means that the rendered video at the video receiver and the video viewer are the same, meaning that the video viewer is viewing exactly what was seen by the video receiver.

FIG. 4(A,B) are examples of devices that may be utilized to provide receiver perspective for mobile streaming video according to the techniques described herein. FIG. 4A depicts an example of a device 400, such as one suitable for use as a video receiver 140, as described in FIG. 1. The device 400 may include a processor 405 coupled to a memory 410. The memory 410 may contain a set of instructions thereon that when executed by the processor cause the processor to implement the techniques described herein.

The memory 410 may be loaded with instructions that are stored on non-transitory processor readable medium 415. The processor 405 may cause instructions from the medium 415 to be loaded into the memory 410 in order to be executed by the processor. The medium 415 may include instructions such as decode instructions 416. The decode instructions may allow the device to receive a video stream. The video stream may be received using wireless transceiver 420. Wireless transceiver 420 may allow the device 400 to communicate with wireless network 160 in order to receive video streams.

The decode instructions 416 may further provide instructions that allow device 400 to decode the video stream and store data related to the decoding process into a decoding log. The decoding log may be used at a later time to recreate the decoding process. The medium 415 may also include render instructions 417. The render instructions may be used to allow the device 400 to take the decoded video stream and render the video stream on a display 425. As mentioned above, the display may be integrated with the device 400 (e.g. screen on a smartphone). In other implementations, the display may be external to the device (e.g. casting the decoded video stream to a remote screen, such as a television screen). The techniques described herein are not dependent on any particular type and or location of the display 425.

The render instructions 417 may further include instructions to store details related to the rendering process in a playout log. The playout log may include the results of the rendering process as well as characteristics of the display 425 on which the video stream is being rendered. The rendering instructions may further include instructions to store the data associated with the rendering to the playout log.

The medium may also include storage instructions 418. The storage instructions may cause the device to store the decoding log and playout log in the DEMS 130. The instructions stored on medium 415 are generally those that allow for implementation of the flow diagram depicted in FIG. 2.

FIG. 4B depicts an example of a device 450, such as one suitable for use as a video viewer 150, as described in FIG. 1. The device 450 may include a processor 455 coupled to a memory 460. The memory 460 may contain a set of instructions thereon that when executed by the processor cause the processor to implement the techniques described herein.

The memory 460 may be loaded with instructions that are stored on non-transitory processor readable medium 465. The processor 455 may cause instructions from the medium 465 to be loaded into the memory 460 in order to be executed by the processor. The medium 465 may include instructions such as decode instructions 466. The decode instructions may allow the device to receive a video stream. The decode instructions 466 may generally be the same as those described with respect to the instructions 416. The video stream may be received using DEMS interface 470. The DEMS interface may allow the device 450 to communicate with DEMS 130 in order to receive video streams that were previously sent to the video receiver 140.

The decode instructions 466 may further provide instructions that allow device 450 to decode the video stream by retrieving the decoding log from the DEMS. The decoding log may be applied to the video stream to recreate the decoding that was done by the video receiver 140. The decoding instructions may further include instructions to generate a hash value over the decoded video stream. The hash value may be generated using the same techniques used by the video receiver. If the hash values produced by the device 450 match those stored in the decoding log generated by the video receiver 140, then it can be ensured that the decoded video stream at the video viewer is the same as the one produced by the video receiver.

The medium 465 may also include rendering instructions 467. The rendering instructions may be used to allow the device 450 to take the decoded video stream and render the video stream on a display 475. As mentioned above, the display may be integrated with the device 450 (e.g. screen on a smartphone). In other implementations, the display may be external to the device (e.g. casting the decoded video stream to a remote screen, such as a television screen). The techniques described herein are not dependent on any particular type and or location of the display 475.

The rendering instructions 467 may further include instructions apply the playout log to the decoded video stream in order to reproduce the rendered video stream. In addition, the decoding instructions 467 may include instructions to generate a digest of the rendered video stream, using the same digest generation process used by the video receiver 140. If the generated digest is the same as the digest created by the video receiver, then it can be ensured that the rendering viewed by the video viewer is the same as that which was seen by the video receiver.

The medium may also include compare instructions 468. The compare instructions may cause the device 450 to compare the hash and digest values from the decoding and playout logs to those that were generated by the video viewer device 450. If the values are the same, it means that the video stream viewed by the video viewer 150 is the exact same as the one viewed by the video receiver 140. The instructions stored on medium 465 are generally those that allow for implementation of the flow diagram depicted in FIG. 3.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. The term “one or more of” when applied herein to two or more subsequently defined options such as “one or more of A and B” should be construed to mean any combination of any one or more of the options in the list alone (e.g., A alone or B alone) or any combination of two or more of the options, or all of the options, in the list together (e.g., A and B together), as well as multiples of each option (e.g. multiple A alone, multiple B alone, multiple A and single B, single A and multiple B, multiple A and multiple B).

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving, by a video receiver device, an encoded video stream transmitted over a wireless communications link;
decoding the encoded video stream;
generating a decoding log, wherein the decoding log stores metadata associated with the decoding;
signing the decoding log; and
sending the signed decoding log to a Digital Evidence Management System (DEMS) for storage.

2. The method of claim 1 further comprising:
generating a playout log, wherein the playout log stores output characteristics of a rendering of the decoded video stream on a viewing device;
signing the playout log; and
sending the signed playout log to the DEMS.

3. The method of claim 1 wherein the metadata associated with the decoding include one or more of:
packets lost over the wireless communications link;
packets discarded during the decoding;
frames discarded during the decoding;
a hash value of at least a portion of at least one video frame;
a hash value of at least one group of pictures (GOP);
a hash value of at least one element of a single video frame; and
device characteristics of the video receiver device.

4. The method of claim 1 wherein the decoding log further includes:
an operating system of the video receiver device;
a chipset used by the video receiver device; and
a decoder used by the video receiver device.

5. The method of claim 2 further comprising:
generating a digest of the rendering of the decoded video stream; and
adding the digest to the playout log.

6. The method of claim 2, wherein the playout log comprises:
any modifications made to the decoded video stream during rendering of the decoded video stream.

7. The method of claim 2, wherein the playout log further comprises:
a status of a device used to render the decoded video stream.

8. The method of claim 5, wherein generating the digest of the rendering of the decoded video stream further comprises:
periodically calculating a hash for at least a portion of at least one frame of the rendered decoded video stream.

9. A non-transitory processor readable medium containing a set of processor executable instructions thereon that when executed by a processor cause the processor to:
retrieve an encoded video stream from a Digital Evidence Management System (DEMS);
retrieve a decoding log from the DEMS;
decode the encoded video stream by applying the decoding log to the encoded video stream; and
render the decoded video stream.

10. The medium of claim 9 further comprising instructions to:
retrieve a playout log from the DEMS evidence management system;
apply the playout log to the decoded video stream; and
generate a digest of the rendered decoded video stream.

11. The medium of claim 10, further comprising instructions to:
retrieve a source digest from the playout log; and
compare the digest and the source digest to determine if the rendered decoded video stream is the same as a video stream used to create the source digest.

12. The medium of claim 9, further comprising instructions to:
transcode the retrieved encoded video stream.

13. A device comprising:
a processor;
a memory coupled to the processor, the memory containing a set of processor executable instructions that when executed by the processor cause the processor to:
receive, by the device, an encoded video stream transmitted over a wireless communications link;
decode the encoded video stream;
generate a decoding log, wherein the decoding log stores metadata associated with the decoding;
sign the decoding log; and
send the signed decoding log to a Digital Evidence Management System (DEMS) for storage.

14. The device of claim 13 further comprising instructions to:
generate a playout log, wherein the playout log stores output characteristics of a rendering of the decoded video stream on a viewing device;
sign the playout log; and
send the signed playout log to the DEMS for storage.

15. The device of claim 13 wherein the metadata associated with the decoding include one or more of:
packets lost over the wireless communications link;
packets discarded during the decoding;
frames discarded during the decoding;
a hash value of at least a portion of at least one video frame;
a hash value of at least one group of pictures (GOP);
a hash value of at least one element of a single video frame; and
device characteristics of the device.

16. The device of claim 13 wherein the decoding log further includes:
an operating system of the device;
a chipset used by the device; and
a decoder used by the device.

17. The device of claim 14 further comprising instructions to:
generate a digest of the rendering of the decoded video stream; and
add the digest to the playout log.

18. The device of claim 14, wherein the playout log comprises:
any modifications made to the decoded video stream during rendering of the decoded video stream.

19. The device of claim 14, wherein the playout log further comprises:
a status of the device used to render the decoded video stream.

20. The device of claim 17, wherein generating the digest of the rendering of the decoded video stream further comprises instructions to:
periodically calculate a hash for at least a portion of at least one frame of the rendered decoded video stream.
